(19) United States
(12) Patent Application Publication
(10) Pub. No.: US 2008/0033966 A1
(43) Pub. Date: Feb. 7, 2008

(54) System and method for recovery detection in a distributed directory service

(76) Inventor: Mark Frederick Wahl, Austin, TX (US)

Correspondence Address: Mark Wahl, PO Box 90626, Austin, TX, 78709, US

(21) Appl. No.: 11/890,410

(22) Filed: Aug. 6, 2007

Related U.S. Application Data
(60) Provisional application No. 60/835,708, filed on Aug. 4, 2006.

(51) Int. Cl. G06F 17/30; G06F 15/16

(52) U.S. Cl. 707/10; 709/219; 707/E17.005

(57) ABSTRACT

A distributed information processing system comprising a collection of servers providing a directory service with a shared view of a directory information tree is augmented with the ability to determine whether one or more of those directory servers have had their view of the directory information tree replaced with one restored from an earlier version of the directory information tree.

### CROSS-REFERENCE TO RELATED APPLICATIONS

This application claims the benefit of PPA Ser. No. 60/835,708 filed Aug. 4, 2006 by the present inventor, which is incorporated by reference.

### FEDERALLY SPONSORED RESEARCH

Not applicable

### SEQUENCE LISTING OR PROGRAM

Not applicable

### BACKGROUND OF THE INVENTION

1. Field of Invention

This invention relates generally to the monitoring of the contents of directory servers in an enterprise computer network.

2. Prior Art

A typical identity management deployment for an organization will incorporate a directory service. In a typical directory service, one or more server computers host instances of directory server software. These directory servers implement the server side of a directory access protocol, such as the X.500 Directory Access Protocol, as defined in the document ITU-T Rec. X.519 Information technology—Open Systems Interconnection—The Directory. Protocol specifications, or the Lightweight Directory Access Protocol (LDAP), as defined in the document Internet RFC 2251 “Lightweight Directory Access Protocol (v3)”, by M. Wahl et al of December 1997. The client side of the directory access protocol is implemented in other components of the identity management deployment, such as an identity manager component or an access manager component.

In order to provide an anticipated level of availability or performance from the directory service when deployed on server computer hardware and directory server software with limits in anticipated uptime and performance, the directory service often will have a replicated topology. In a replicated topology, there are multiple directory servers present in the deployment to provide the directory service, and each directory server holds a replica (a copy) of each element of directory information. One advantage of a replicated topology in an identity management deployment is that even if one directory server is down or unreachable, other directory servers in the deployment will be able to provide the directory service to other components of the identity management deployment. Another advantage is that directory service query operations in the directory access protocol can be processed in parallel in a replicated topology: some clients can send queries to one directory server, and other clients can send queries to other directory servers.

Some directory server implementations which support the X.500 Directory Access Protocol also support the X.500 Directory Information Shadowing Protocol (DISP), as defined in the document ITU-T Rec. X.519, Information technology—Open Systems Interconnection—The Directory: Protocol specifications.

It is common in many enterprises for there to be directory server implementations which do not support the X.500 Directory Access Protocol. While each of these implementations also support replication, the replication protocol each implementation supports is not based on DISP or any other standard, and thus each implementation typically only supports replication between two or more directory servers of the same implementation. In some organizations, a metadirectory provides synchronization between the contents of directory servers which do not have support for a common replication protocol.

In an identity management deployment, the failure of any particular server computer system, directory server software, metadirectory software, or network link supporting the deployment can cause the deployment to be partitioned, and the directory servers and metadirectory servers in this situation are no longer able to maintain consistency of the directory contents among all the servers. In a scenario in which a component of the deployment has become unavailable, one set of directory servers might have more recent directory data, incorporating changes that have not been sent to another set of directory servers.

Deprovisioning a user account, such as for an employee, customer, or partner, typically involves either deleting the directory entry corresponding to the user, or changing an attribute in that user's entry which indicates the entry is no longer suitable for granting access. However, should one or more of the directory server's contents become damaged and then restored from a backup copy of that directory server's database, and if replication to these servers is temporarily suspended or delayed, directory clients will be able to see the old contents of entries in the directory, as of the date of the backup. This directory server's database may then include entries which had subsequent to the date of the backup been disabled or deleted, and unauthorized access might be granted to deprovisioned users.

### SUMMARY

This invention defines and implements a procedure to detect when a directory server in a distributed directory service has had its database recovered. The goal of this invention is to minimize the possibility that a user whose accounts had been deleted or disabled will regain access to systems based on their entry's contents as it existed during a past time period becoming visible again in a particular directory server's directory information tree.

### OBJECTS AND ADVANTAGES

In a prior art system, directory servers periodically report events indicating that they are online to a central component. However, a limitation of this prior art system is that a directory server may indicate that it is online, but due to a network partition, or a server elsewhere in the network being unavailable, may not be capable of participating in replication, and thus may have out of date content in its directory information tree. One advantage of this invention over prior art systems is that in this invention, the central component contacts each directory server at regular intervals to validate that the directory server holds recently updated entries in its directory information tree.

### DRAWINGS

### Figures

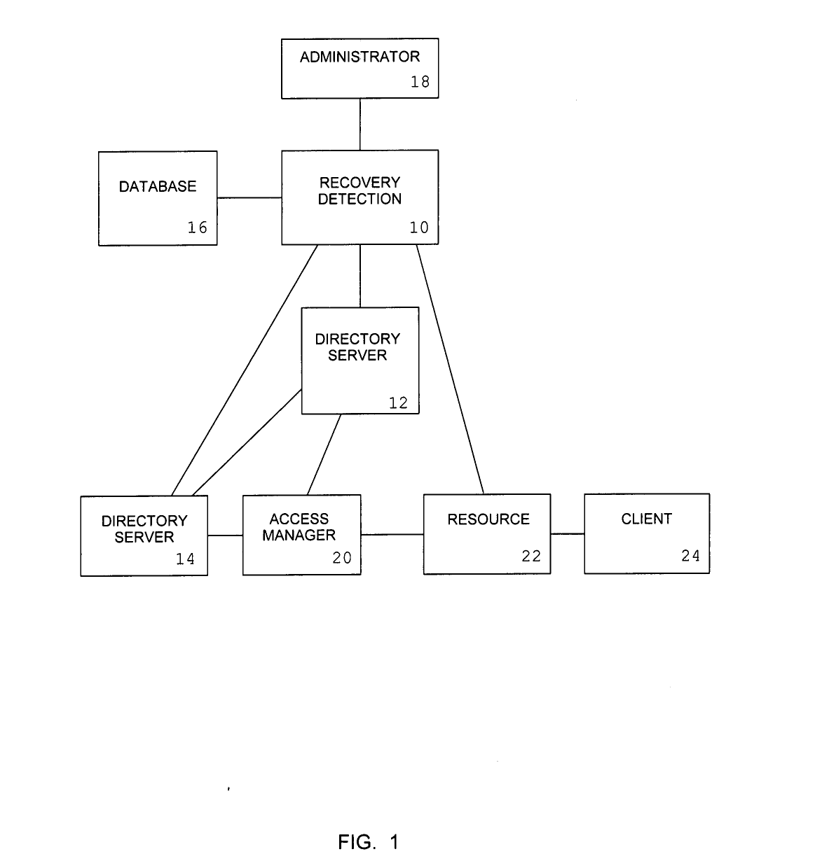

FIG. 1 is a diagram illustrating the components of the system to detect recovery in a distributed directory service.

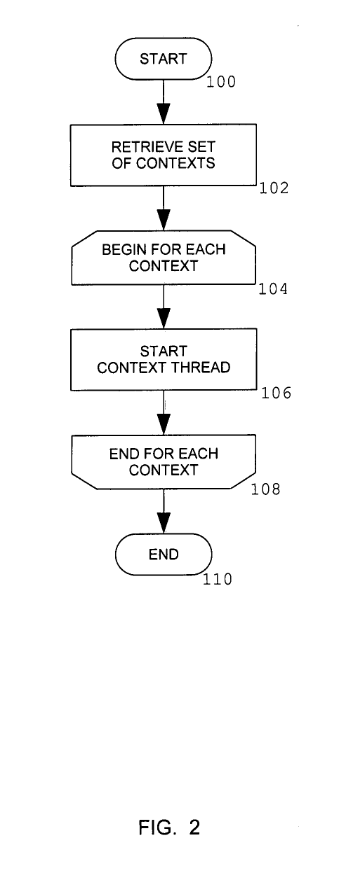

FIG. 2 is a flowchart illustrating the behavior of the primary thread of the recovery detection component.

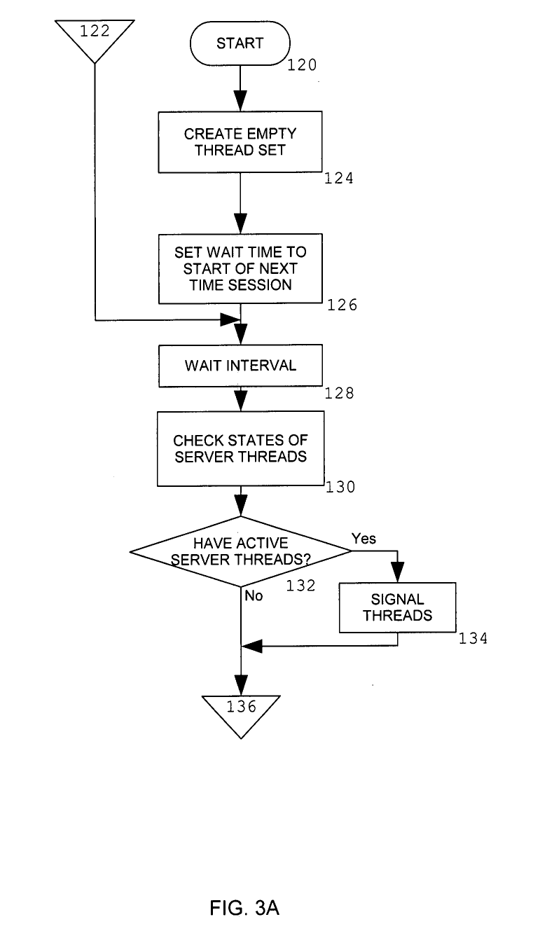

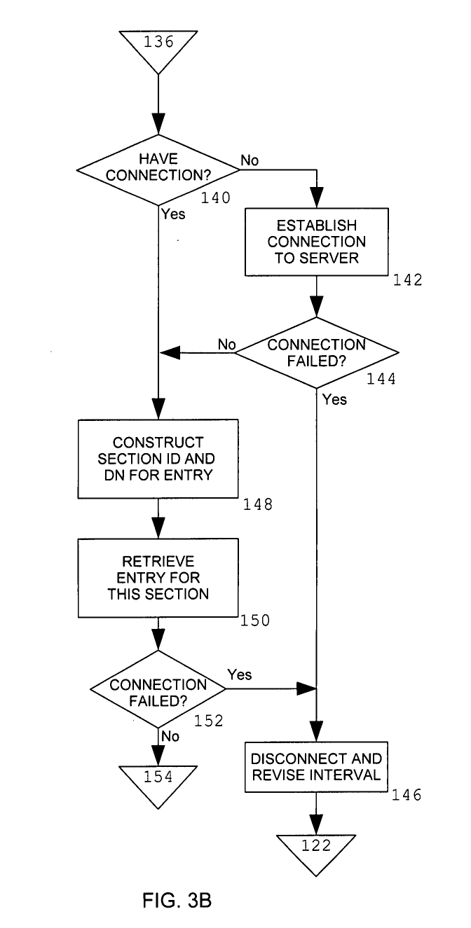

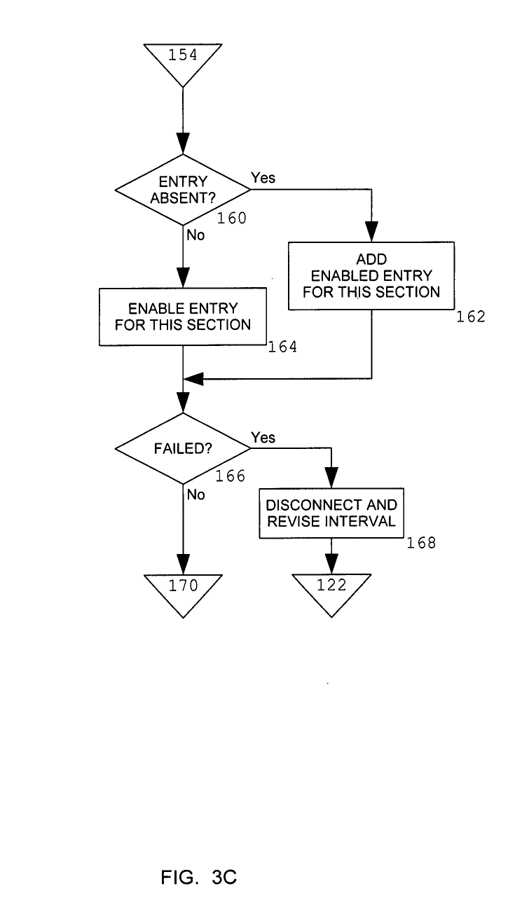

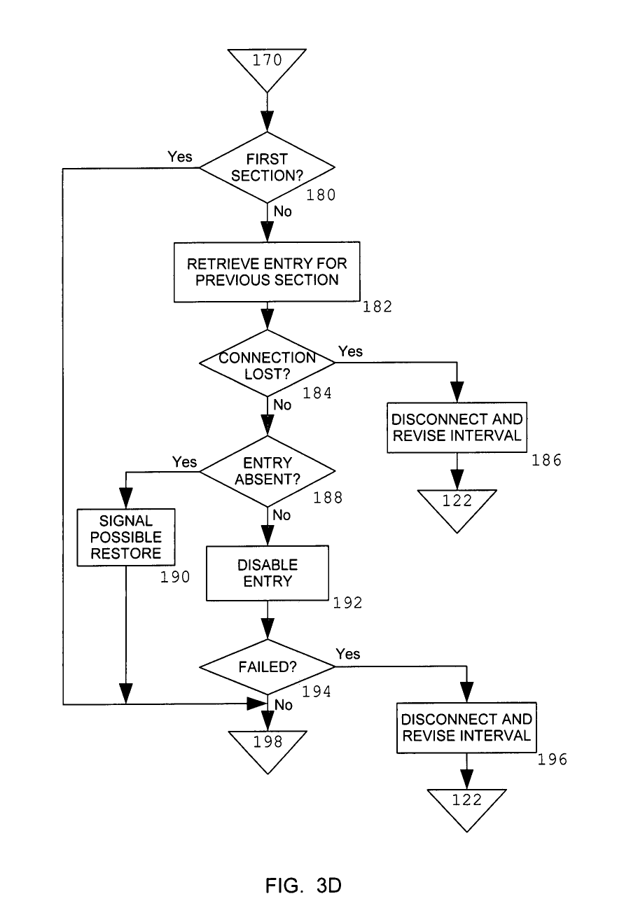

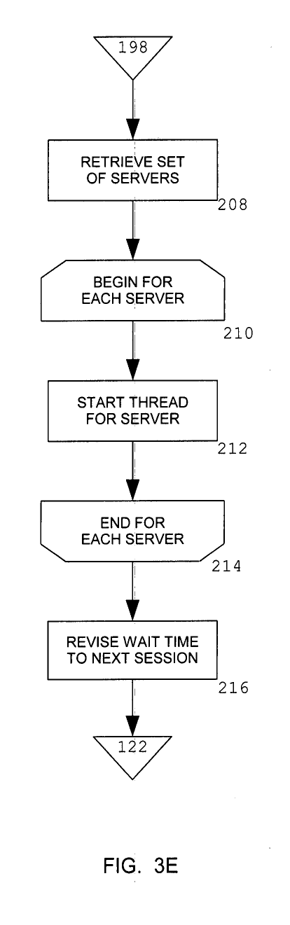

FIG. 3A, FIG. 3B, FIG. 3C, FIG. 3D and FIG. 3E are a flowchart illustrating the behavior of a context thread of the recovery detection component.

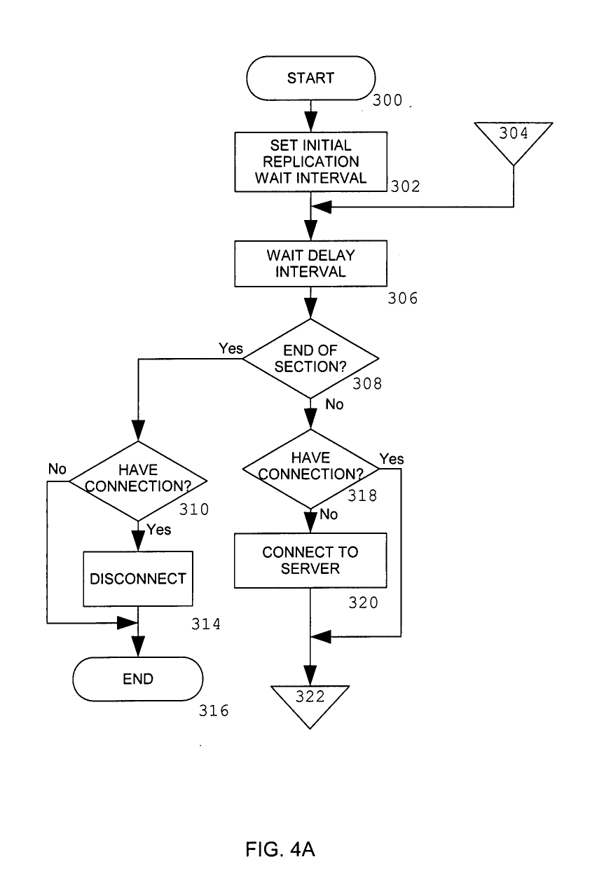

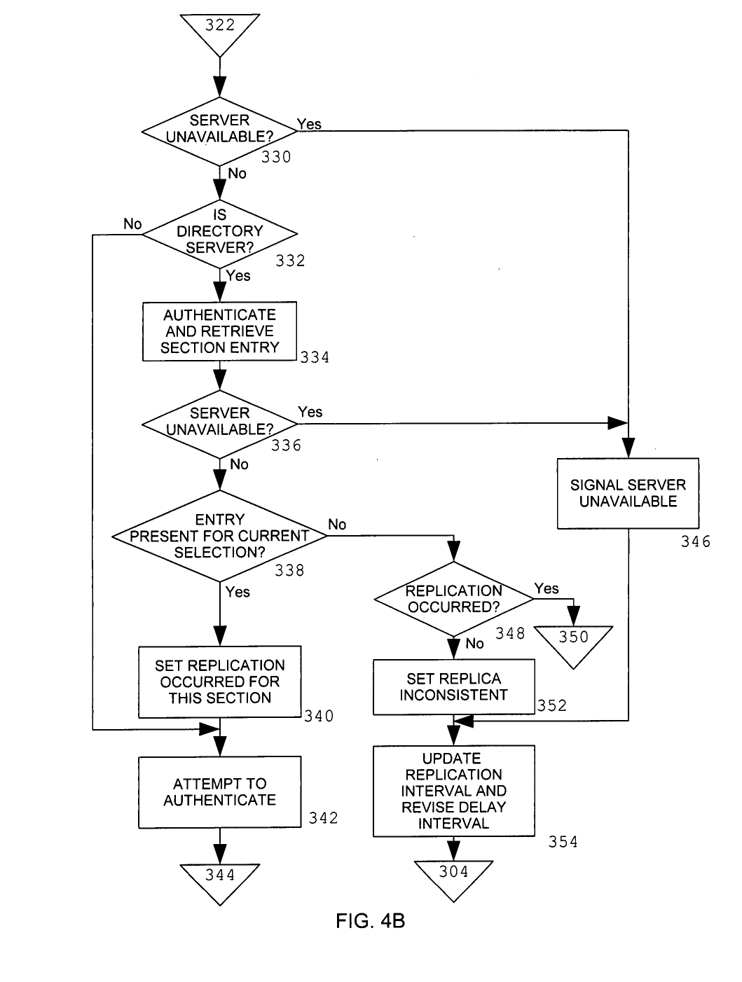

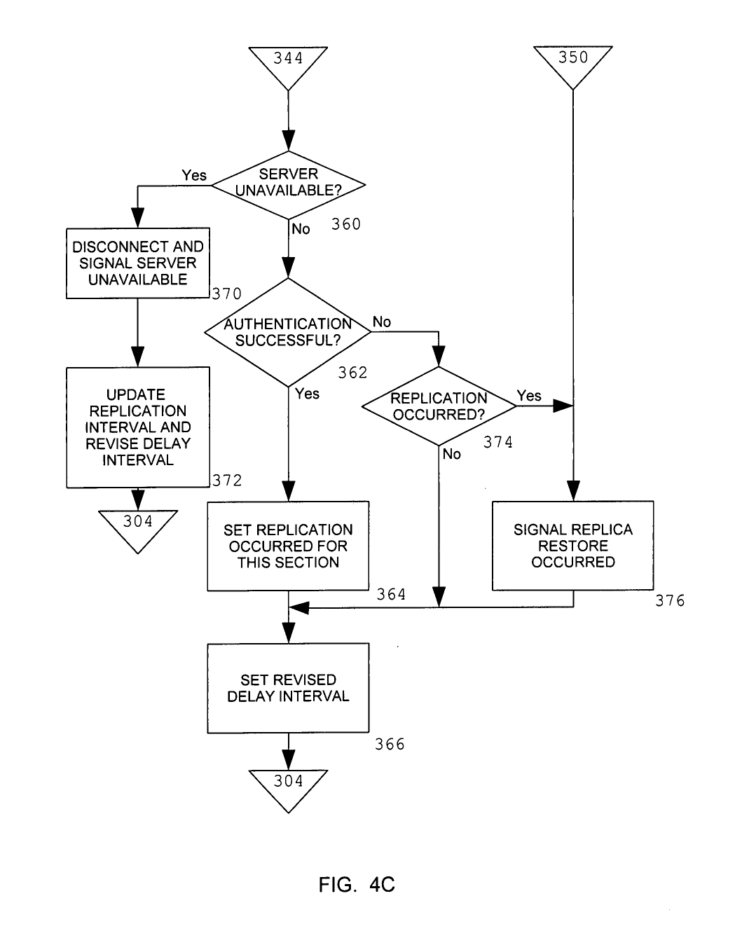

FIG. 4A, FIG. 4B and FIG. 4C are a flowchart illustrating the behavior of a directory server thread of the recovery detection component.

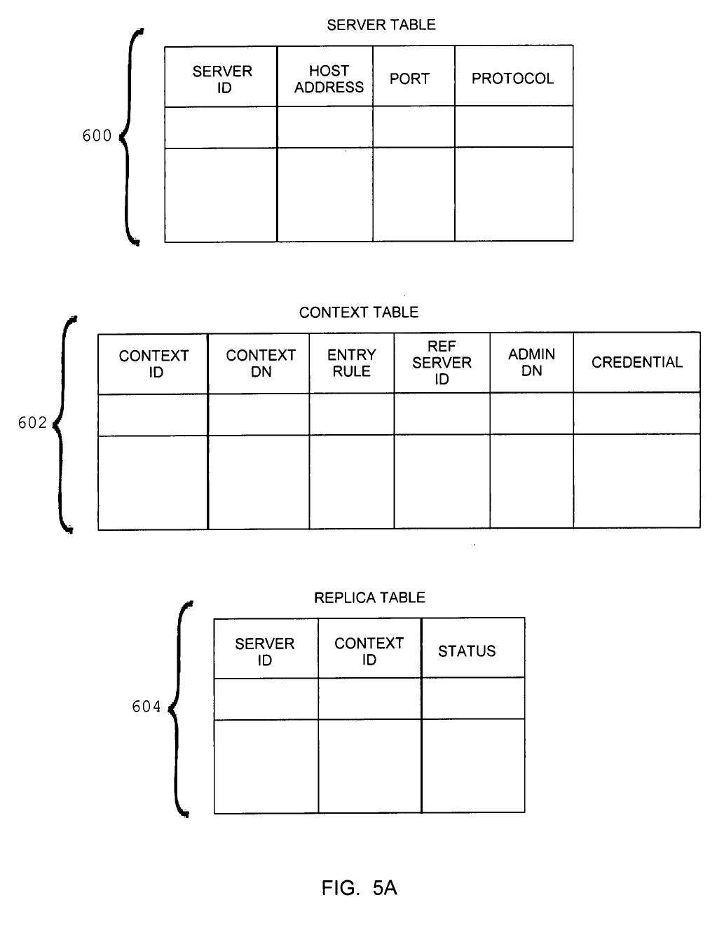

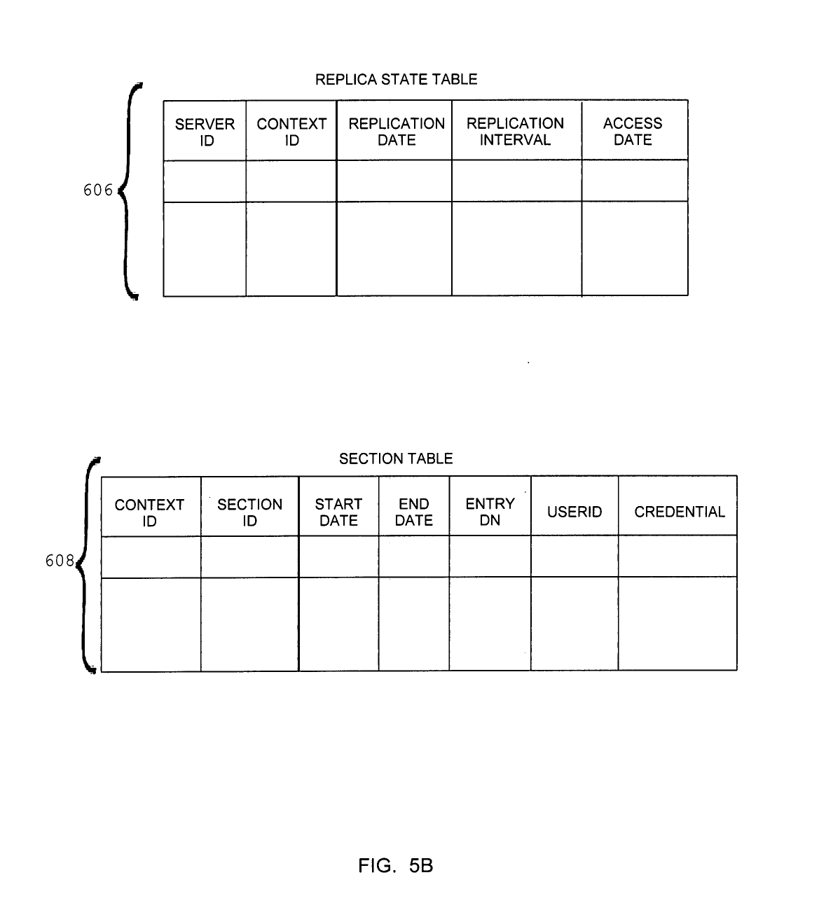

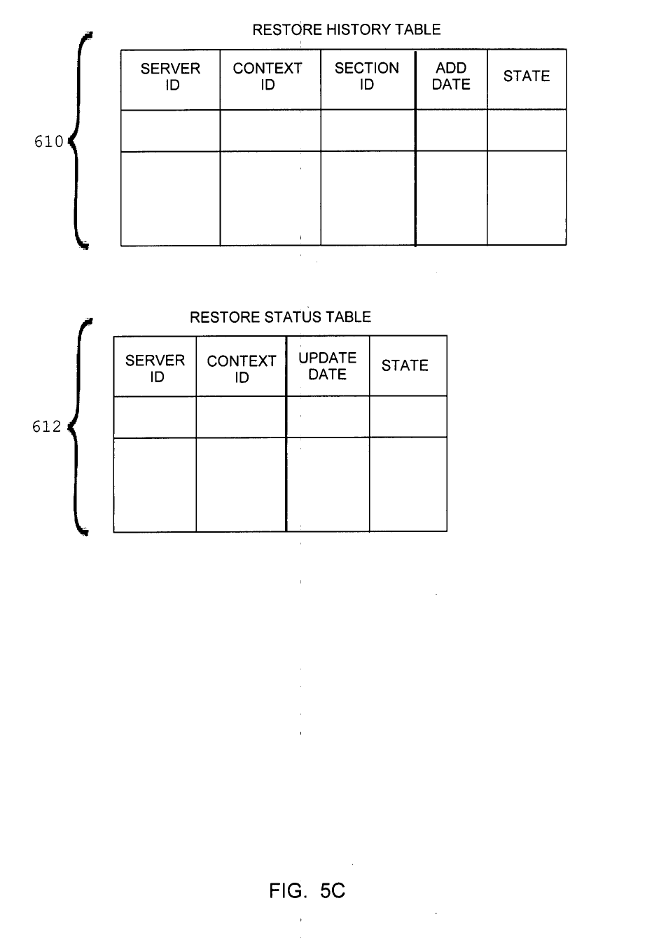

FIG. 5A, FIG. 5B and FIG. 5C are diagrams illustrating the tables of the database (16).

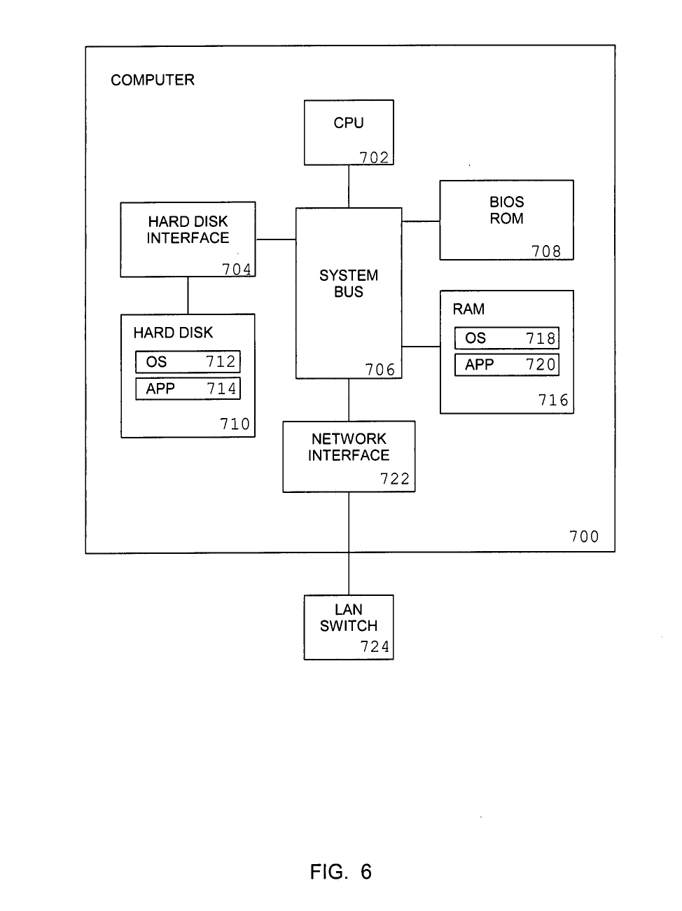

FIG. 6 is a diagram illustrating the typical components of a server computer.

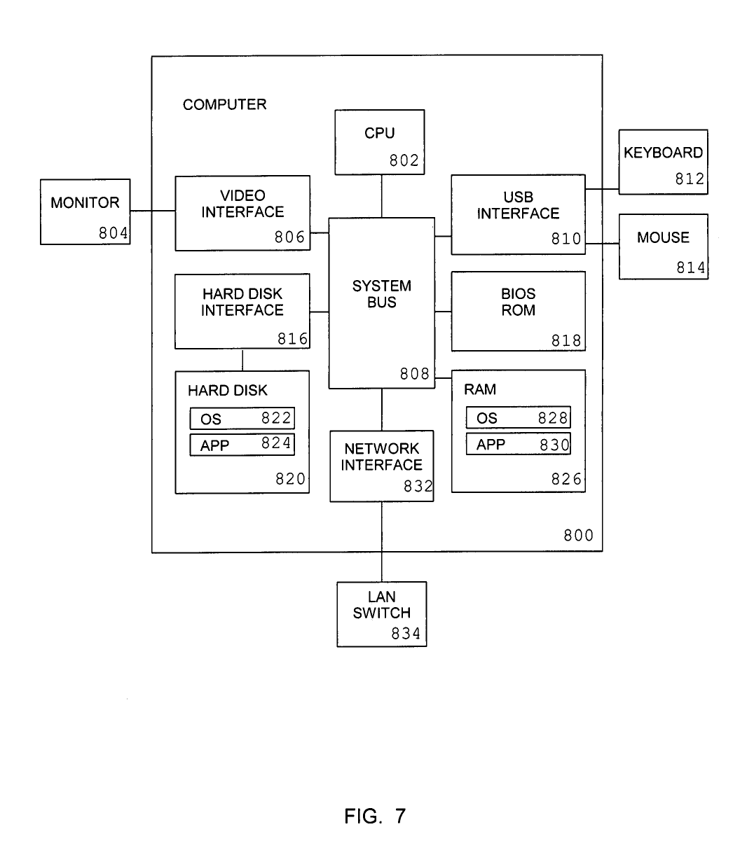

FIG. 7 is a diagram illustrating the typical components of a workstation computer.

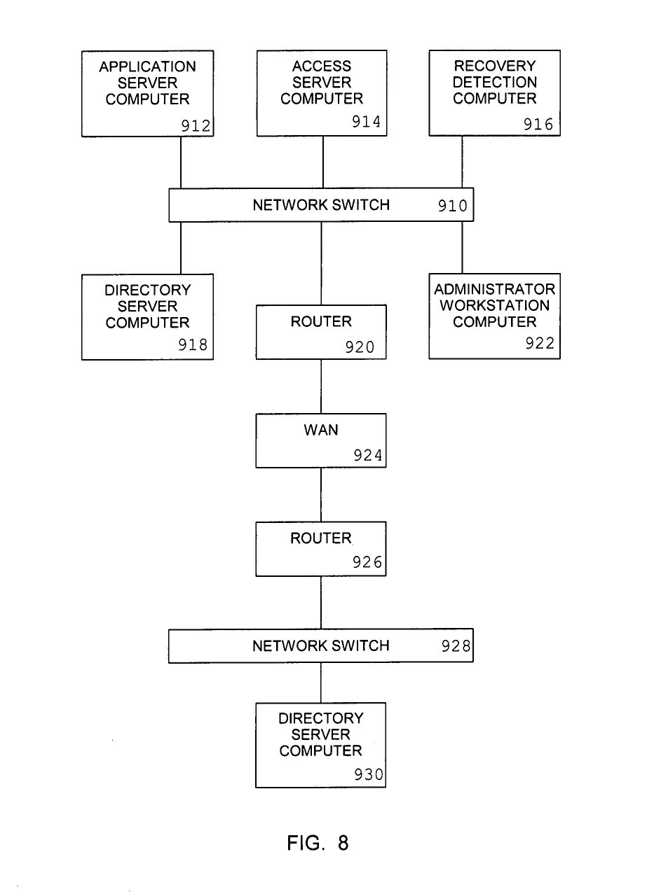

FIG. 8 is a diagram illustrating the typical components of an enterprise network and computer systems of an identity management deployment that spans multiple physical locations.

### REFERENCE NUMERALS

10 recovery detection
12 directory server
14 directory server
16 database
18 administrator
20 access manager
22 application resource
24 client
600 server table
602 context table
604 replica table
606 replica state table
608 section table
610 restore history table
612 restore status table
700 computer
702 CPU
704 hard disk interface
706 system bus
708 BIOS ROM
710 hard disk
712 operating system state stored on hard disk
714 application state stored on hard disk
716 RAM
718 operating system state in memory
720 application state in memory
722 network interface
724 LAN switch
800 workstation computer
802 CPU
804 monitor
806 video interface
808 system bus
810 USB interface
812 keyboard
814 mouse
816 hard disk interface
820 hard disk
822 operating system state stored on hard disk
824 application state stored on hard disk
826 RAM
828 operating system state in memory
830 application state in memory
832 network interface
834 LAN switch
910 network switch
912 application server computer
914 access server computer
916 recovery detection computer
918 directory server computer
920 router
922 administrator workstation computer
924 wide area network
926 router
928 network switch
930 directory server computer

### DETAILED DESCRIPTION

The invention comprises the following components:
a recovery detection component (10),
a database (16),
an administrator (18),
a reference directory server (12),
one or more observation directory servers (14),
an access manager (20), and
an application resource (22).

The recovery detection component (10) is a software component comprising one or more threads of execution. These threads monitor the directory servers (12, 14) and identify those directory servers which have been restored, and thus are no longer holding current information. This is achieved by the recovery detection component, at regular time sections, adding or enabling an entry in the directory information tree that is held by a reference directory server, and then attempting authentication as that entry to each directory server. The time sections are of a constant size, whose value is to be determined to be larger than the estimated duration of the time for a change to be replaced to each directory server holding a copy of the directory information tree. The entry being added or enabled holds authentication credentials known to the recovery detection component. Should the authentication fail at a particular directory server after replication has already occurred to that directory server, this indicates that the contents of that directory server may have been restored. The behavior of these threads is illustrated by the flowcharts of FIG. 2, FIG. 3A, FIG. 3B, FIG. 3C, FIG. 3D, FIG. 3E, FIG. 4A, FIG. 4B, and FIG. 4C.

The database (16) is a software component that maintains the persistent state of the recovery detection component (10). The database can be implemented as a relational database, which comprises seven tables: the server table (600), the context table (602), the replica table (604), the replica state table (606), the section table (608), the restore history table (610) and the restore status table (612). The structure of these tables is illustrated by the diagrams of FIG. 5A, FIG. 5B and FIG. 5C.

Each directory server is represented by a row in the server table (600), and each resource is also represented by a row in that table. Rows are created in this table by the administrator. At least one row must be present in this table. The primary key of the server table is the SERVER ID column. The columns of this table are:
SERVER ID: a unique identifier for the server,
HOST ADDRESS: the internet protocol (IP) network address of the server,
PORT: the transmission control protocol (TCP) port number of the server, and
PROTOCOL: a string comprising an indicator of the protocol used to interact with the server.

Examples of protocol indication strings used as values of the PROTOCOL column in rows in the server table (600) include “ldap” for the Lightweight Directory Access Protocol (LDAP), “ldaps” for the Lightweight Directory Access Protocol carried over the Secure Sockets Layer (SSL), and “http” for the Hypertext Transport Protocol (HTTP). The “Idap” and “ldaps” protocols are typically used to indicate a connection to directory server, and “http” is used to indicate a connection to another form of application resource.

There is one row in the context table (602) for each namespace context in the directory information tree stored in the directory servers. Rows are created in this table by the administrator. At least one row must be present in this table. The primary key of the context table is the CONTEXT ID column. The columns of this table are:
CONTEXT ID: a unique identifier for the context
CONTEXT DN: the base distinguished name for the context,
ENTRY RULE: a rule describing how distinguished names are to be constructed for entries added to this context,
REF SERVER ID: the value of the SERVER ID column in a row in the server table (600) for an updatable reference directory server which holds this context,
ADMIN DN: the distinguished name of an account which has been granted privileges to add, enable and disable entries in this context, and
CREDENTIAL: the administrator authentication credential, such as a password, that is used when authenticating as the account named in the value of the ADMIN DN column.

There is one row in the replica table (604) for each namespace context that is held in each directory server. At least one row must be present in this table. The primary key of the replica table is the combination of the SERVER ID column and the CONTEXT ID column. The columns of this table are:
SERVER ID: the value of the SERVER ID column in a row in the server table (600) of a directory server which holds a namespace context,
CONTEXT ID: the value of the CONTEXT ID column in a row in the context table (602) of a namespace context, and
STATUS: the configured status of this relationship.

Examples of values used in the STATUS column in rows in the replica table (604) include “disabled”, to indicate that the replication of the namespace context to the directory server has been temporarily disabled, and “deleted”, to indicate that the replication of the namespace context to the directory server has been permanently disabled. A NULL value in the STATUS column indicates that replication is anticipated to occur for the specified namespace context to the specified directory server.

There is one row in the replica state table (606) for each namespace context in each directory server. The primary key of the replica state table is the combination of the SERVER ID column and the CONTEXT ID column. The columns of this table are:
SERVER ID: the value of the SERVER ID column in a row in the server table (600) of a directory server which holds a namespace context,
CONTEXT ID: the value of the CONTEXT ID column in a row in the context table (602) of a namespace context,
REPLICATION DATE: the date and time that the replication component last detected replication occurring from the reference directory server for the namespace context to the directory server indicated in the SERVER ID column,
REPLICATION INTERVAL: the estimated replication interval time between which an entry is added or enabled in the reference directory server for the namespace context and that entry is available in the directory server indicated in the SERVER ID column, and
ACCESS DATE: the date and time the server was last accessed by the recovery detection component.

There is one row in the section table (608) for each combination of time section and namespace context. Rows are added to this table by the recovery detection component. The primary key of the section table is the combination of the CONTEXT ID column and the SECTION ID column. The columns of this table are:
CONTEXT ID: the value of the CONTEXT ID column in a row in the context table (602) of a namespace context,
SECTION ID: a unique identifier for this time section,
START DATE: the starting date and time of the time section,
END DATE: the ending date and time of the time section,
ENTRY DN: the distinguished name of the entry enabled for this time section,
USERID: a userid associated with the entry enabled for this time section, and
CREDENTIAL: the authentication credential to authenticate as this entry.

There is one row in the restore history table (610) for each combination of time section, directory server and namespace context in which a recovery is detected. Rows are added to this table by the recovery detection component. The primary key of the restore history table is the combination of the SERVER ID column, the CONTEXT ID column, and the SECTION ID column. The columns of this table are:
SERVER ID: the value of the SERVER ID column in a row in the server table (600) of a directory server which holds a namespace context,
CONTEXT ID: the value of the CONTEXT ID column in a row in the context table (602) of a namespace context,
SECTION ID: the value of the SECTION ID column in a row in the section table (608) of a time section in which a restore was detected,
ADD DATE: the date and time this row was added to the table, and
STATE: the status of this row, to be updated by the administrator (18) to indicate the cause of the recovery that was detected.

There is one row in the restore status table (612) for each combination of directory server and namespace context in which a recovery is detected. Rows are added to this table by the recovery detection component. The primary key of the restore status table is the combination of the SERVER ID and CONTEXT ID columns. The columns of this table are:
SERVER ID: the value of the SERVER ID column in a row in the server table (600) of a directory server which holds a namespace context,
CONTEXT ID: the value of the CONTEXT ID column in a row in the context table (602) of a namespace context,
UPDATE DATE: the date and time this row was added or updated by the recovery component, and
STATE: the status of this row, to be updated by the administrator (18) to indicate the cause of the recovery that was detected.

The directory servers (12 and 14) are server software components that each maintain an internal database of directory entries, and implement the server side of a directory access protocol, such as the X.500 Directory Access Protocol or LDAP. Examples of implementations of directory servers include Microsoft Active Directory, the Sun Java Enterprise System Directory Server, OpenLDAP directory server, and the Novell eDirectory Server.

The access manager (20) is a software component which receives authentication requests from an application resource (22), and relies upon one or more directory servers (12 and 14) to validate the authentication requests.

The application resource (22) is a server software component which receives requests from an application client (24) and from the recovery detection component (10).

The processing components of this invention can be implemented as software running on computer systems on an enterprise computer network.

FIG. 8 illustrates an example enterprise computer network. This enterprise computer network comprises two local area networks, implemented by network switches (910 and 930), and interconnected by a wide area network (924). In this enterprise computer network, the recovery detection component (10) can be implemented as software running on the recovery detection computer (916), the database component (16) can be implemented as software also running on the recovery detection computer (916), the directory server components (12, 14) can be implemented as software running on the directory server computers (918 and 930), the access manager component (20) can be implemented as software running on the access server computer (914), and the resource component (22) can be implemented as software running on the application server computer (912). In this network, the application server computer (912), access server computer (914), recovery detection computer (916), directory server computers (918 and 930) are server computers, and the administrator workstation computer (922) is a workstation computer.

FIG. 6 illustrates the typical components of a server computer (700). Components of the computer include a CPU (702), a system bus (706), a hard disk interface (704), a hard disk (710), a BIOS ROM (708), random access memory (716), and a network interface (722). The network interface connects the computer to a local area network switch (724). The hard disk (710) stores the software and the persistent state of the operating system (712) and applications (714) installed on that computer. The random access memory (716) holds the executing software and transient state of the operating system (718) and application processes (720).

FIG. 7 illustrates the typical components of a workstation computer (800). Components of the computer include a CPU (802), a system bus (808), a hard disk interface (816), a hard disk (820), a BIOS ROM (818), random access memory (826), a video interface (806), a USB interface (810), and a network interface (832). The video interface connects the computer to a monitor (804). The USB interface connects the computer to a keyboard (812) and a mouse (814). The network interface connects the computer to a local area network switch (834). The hard disk (820) stores the software and the persistent state of the operating system (822) and applications (824) installed on that computer. The random access memory (826) holds the executing software and transient state of the operating system (828) and application processes (830).

### Operations

The recovery detection component comprises one or more threads of execution, which may execute in parallel with each other. There are three kinds of threads: the primary thread, the context threads, and the server threads.

The behavior of the primary thread is illustrated by the flowchart of FIG. 2. There is a single primary thread within the recovery detection component, and this thread executes once, when the recovery detection component starts. At step 102, the thread will obtain the set of contexts from the database, by retrieving the rows of the context table (602). At step 104, the thread will iterate through the set of contexts. At step 106, the thread will start a context thread, whose behavior is illustrated by the flowchart of FIG. 3A, FIG. 3B, FIG. 3C, FIG. 3D and FIG. 3E and discussed in the next paragraph, providing to it the values obtained from the columns of the row for the context. At step 110, the primary thread will exit.

The behavior of a context thread is illustrated by the flowchart of FIG. 3A, FIG. 3B, FIG. 3C, FIG. 3D and FIG. 3E. There is one context thread in the recovery detection component for each context configured in the database. A context thread is started by the primary thread, and is provided with the values obtained from a row of the context table (602). At step 124, the context thread will create an empty thread set. At step 126, the thread will set the wait time to the start time of the next time session. At step 128, the thread will wait the interval between the current time and the wait time. At step 130, the thread will check the states of the server threads in the server thread set which this context thread has created. At step 132, the thread will test whether there are any server threads in the server thread set which are still running or blocked. If so, then at step 134 the thread will signal each of these server threads from the server thread set to exit, and will clear the server thread set. At step 140, the thread will test whether it has an active connection to the reference directory server (the directory server indicated by the reference server ID). If the thread does not have an active connection, then at step 142 the thread will establish a connection to the directory server indicated by the reference server ID, and authenticate using the admin DN and admin credentials obtained from the row of the context table (602). If the connection attempt failed, then at step 146 the thread will unbind the connection from the reference directory server, revise the delay interval based on a truncated binary exponential backoff algorithm, and loop back to step 128. Otherwise, at step 148 the thread will construct a distinguished name, the entry DN, for an entry to be added, based on the context DN and entry rule of the context, and a userid which corresponds to that entry DN. If the thread has not yet created a section ID for this thread, then the thread will create a section ID for this section and a new credential, determine the end date and time for this section, and add a row to the section table (608). At step 150, the thread will attempt to retrieve this entry from the reference directory server over the connection, by submitting a search request with the scope set to baseObject, the base DN set to the entry DN, and the filter set to a presence match of the objectClass attribute. If the connection to the server failed, then at step 146 the thread will unbind the connection from the reference directory server, revise the delay interval based on a truncated binary exponential backoff algorithm, and loop back to step 128. At step 160, the thread will test whether an entry was returned from the search. If an entry was not returned, then at step 162 the thread will add an enabled entry for this section, by sending an add request to the reference directory server to create the entry. Otherwise, if an entry was returned, then at step 164 the thread will enable the entry for this section, by sending a modify request to the reference directory server to update the entry with an attribute which causes the directory server to permit authentication as that entry. If the add or modify operation failed, then at step 168 the thread will unbind the connection to the reference directory server, revise the delay interval based on a truncated binary exponential backoff algorithm, and loop back to step 128. At step 180, the thread will test whether this is the first time section handled for this context. If this is not the first time section, then at step 182 the thread will retrieve the distinguished name for the previous section and retrieve this entry from the reference directory server, by submitting a baseObject search for this entry's distinguished name. If the connection to the reference directory server is lost, then at step 186 the thread will disconnect, revise the delay interval based on a truncated binary exponential backoff algorithm, and loop back to step 128. If the entry was not returned by the reference directory server, then at step 190 the thread will signal a possible restore of the reference directory server, by adding a row to the restore history table (610), and either adding a row to the restore status table (612) if one is not present for this server and context, or updating the value in the UPDATE DATE column of the row if a row is present. Otherwise, at step 192 the thread will disable the entry for the previous section by sending a modify request to the reference directory server to update the entry with an attribute which causes the directory server to deny authentication as that entry. If this operation failed, then at step 196 the thread will disconnect, revise the delay interval based on a truncated binary exponential backoff algorithm, and loop back to step 128. At step 208, the thread will retrieve a set of observation servers for this context from the database, by searching the replica table (604) for rows in which the value of the CONTEXT ID column matches the context ID returned from the context table, and the value in the STATUS column is NULL. At step 210, the thread will iterate through each server in the set of observation servers. At step 212, for each server, the thread will start a new server thread for the server, and provide the thread with the SERVER ID and CONTEXT ID from the row of the replica table, the admin DN and admin credentials from the row of the context table, and the SECTION ID, end time, userid, entry DN and credentials of the section. The behavior of the server thread is illustrated by the flowchart of FIG. 4A, FIG. 4B and FIG. 4C and discussed in the next paragraph. At step 216, after traversing the set of observation servers, the context thread will revise the wait time to be the start time of the next section and loop back to step 128.

The behavior of a server thread is illustrated by the flowchart of FIG. 4A, FIG. 4B, and FIG. 4C. At step 302, the thread will determine the initial replication wait interval, by searching the replica state table (606) for a row in which the value of the SERVER ID column matches the SERVER ID provided to this thread and the value of the CONTEXT ID column matches the CONTEXT ID provided to this thread. If a row is found in the replica state table, then the thread will set the initial replication wait interval to be the value of the REPLICATION INTERVAL column divided by 2; otherwise the thread will set the initial replication wait interval to be a small constant value, such as 10 milliseconds. The thread will set the replica inconsistent flag to false, set the replication has occurred for this section flag to false, and set the delay interval to the initial replication wait interval. At step 306, the thread will wait the delay interval. At step 308, the thread will test whether the current time is later than the end time of the section. If the end time has been reached, and a connection is still open to a server, then at step 314 the connection will be closed. If the end time has been reached, then at step 316 the thread will exit. Otherwise, at step 318, the thread will test whether there is a connection open to the server. If a connection is not open, then at step 320 the thread will open a connection by searching the server table (600) for a row which in which the value of the SERVER ID column matches the SERVER ID provided to the thread, and connecting to the computer indicated by the value of the HOST ADDRESS column of that row at the port indicated by the value of the PORT column of that row, using the protocol indicated by the value of the PROTOCOL column of that row. At step 330, the thread will test whether the server is unavailable. If the server is unavailable, then at step 346 the thread will signal that the server is unavailable by sending a message to the administrator (18), such as by sending a Simple Network Management Protocol (SNMP) trap to the administrator workstation computer (922). If the server is unavailable, then the thread will continue at step 354. Otherwise, at step 332 the thread will test whether the server is a directory server by checking whether the protocol value obtained from the row of the server table matches one of “ldap” or “ldaps”. If the server is not a directory server, then the thread will continue at step 342. Otherwise, at step 334 the thread will authenticate to the directory server on the connection, by sending a bind request using the admin DN and admin credentials that were provided to the thread. The thread will retrieve the entry for the section from the directory server by sending a search request with the scope set to baseObject, the DN set to the entry DN of the section, and the filter set to a presence match of the objectclass attribute. If the directory server was unavailable, then at step 346 the thread will signal that the server is unavailable by sending a message to the administrator (18), such as by sending an SNMP trap to the administrator workstation computer (922). If the directory server was unavailable, then the thread will continue at step 354. Otherwise, if the server was available, then at step 348 the thread will test whether the entry for the section was returned. If the entry was not returned (the server returned a noSuchObject error or zero entries in the response), and the flag that replication occurred has been set to true, then the thread will continue processing at step 376. If the entry was not returned and the flag indicating that replication has occurred for this time section had not been set to true, then at step 352 the thread will set the flag that the replica inconsistent to true. At step 354 the thread will, if a row was found in the replica state table, update the value in the REPLICATION INTERVAL column to be the difference in time between the current time and the starting time of this thread, and will revise the delay interval based on a truncated binary exponential backoff algorithm. The thread will then loop back to step 306. Otherwise, if the entry was returned by the directory server, then at step 340 the thread will set the flag that replication has occurred for this section to true, and continue to step 342. At step 342, the thread will attempt to authenticate to the server over the connection. If the server is a directory server, then the thread will send a bind request to authenticate as the entry DN with the credentials for the section. If the server is not a directory server, then the thread will authenticate to the server with the userid and credentials for the section. At step 360, the thread will test whether the server was unavailable. If the server was unavailable, then at step 370 the thread will disconnect from the server and signal the server was unavailable by sending a message to the administrator (18), such as by sending an SNMP trap to the administrator workstation computer (922). At step 372 the thread will, if a row was found in the replica state table, update the value in the REPLICATION INTERVAL column to be the difference in time between the current time and the starting time of this thread, and revise the delay interval based on a truncated binary exponential backoff algorithm, and then the thread will loop back to step 306. Otherwise, if the server was available, then the thread will test whether the authentication was successful. If the authentication was not successful, and replication had occurred for this time section, then the thread will continue processing at step 376. If the authentication was successful, then the thread will set the flag that replication occurred for this time section to true. At step 366, the thread will set a revised delay interval based on a truncated binary exponential backoff algorithm, and loop back to step 306.

At step 376, the thread will signal a possible restore of the directory server, by adding a row to the restore history table (610), and either adding a row to the restore status table (612) if one is not present for this server and context, or updating the value in the UPDATE DATE column of the row if a row is present. The thread will then continue at step 366.

### CONCLUSIONS

Many different embodiments of this invention may be constructed without departing from the scope of this invention. While this invention is described with reference to various implementations and exploitations, and in particular with respect to systems for monitoring the status of replication in directory servers to detect recovery, it will be understood that these embodiments are illustrative and that the scope of the invention is not limited to them.

What is claimed is:

1. A method of determining whether database recovery has occurred in a database of an observation server in a distributed database system, said method comprising:
(a) adding an entry to a reference server to cause said entry to become part of a database of said reference server,
(b) replicating said entry from said database of said reference server to said database of said observation server, and
(c) authenticating to said observation server as said entry to verify that said entry is part of said database of said observation server.

2. The method of claim 1, wherein said adding comprises submitting an add operation over a transport connection to said reference server using a lightweight directory access protocol.

3. The method of claim 2, wherein said submitting further comprises communicating over a secure sockets layer session connection.

4. The method of claim 1, wherein said adding is repeatedly performed on a periodic basis.

5. The method of claim 1, wherein said authenticating comprises submitting a bind request over a transport connection to said observation server using a lightweight directory access protocol.

6. The method of claim 5, wherein said submitting further comprises communicating over a secure sockets layer session connection.

7. The method of claim 1, wherein said authenticating comprises submitting an authentication request over a transport connection to said observation server using a hypertext transport protocol.

8. A system for determining whether database recovery has occurred in a database of an observation server in a distributed database system, said system comprising:
(a) a reference server,
(b) a database of said reference server,
(c) said observation server,
(d) said database of said observation server, and
(e) a recovery detection component, wherein
said recovery detection component will periodically add an entry to said reference server to cause said entry to become part of said database of said reference server, wait until said entry is replicated from said database of said reference server to said database of said observation server, request authentication to said observation server as said entry, and validate a result of said authentication request to verify that said entry is part of said database of said observation server.

9. The system of claim 8, wherein said reference server, said observation server, and said recovery detection component are implemented as software running on a general-purpose computer system.

10. The system of claim 8, wherein said add operation is submitted to said reference server using a lightweight directory access protocol over a transport connection.

11. The system of claim 8, wherein said add operation is submitted to said reference server using a lightweight directory access protocol over a secure sockets layer session connection.

12. The system of claim 8, wherein said request authentication operation is submitted to said observation server using a lightweight directory access protocol over a transport connection.

13. The system of claim 8, wherein said request authentication operation is submitted to said reference server using a lightweight directory access protocol over a secure sockets layer session connection.

14. The system of claim 8, wherein said request authentication operation is submitted to said observation server using a hypertext transport protocol over a transport connection.

15. A computer program product within a computer usable medium with software for determining whether database recovery has occurred in an observation server in a distributed database system, said computer program product comprising:
(a) instructions for adding an entry to a reference server to cause said entry to become part of a database of said reference server,
(b) instructions for waiting until said entry is replicated from said database of said reference server to said database of said observation server,
(c) instructions for requesting authentication to said observation server as said entry, and
(d) instructions for validating a result of said authentication request to verify that said entry is part of said database of said observation server.

16. The system of claim 15, wherein said instructions for adding an entry comprises software for submitting an add request using a lightweight directory access protocol over a transport connection.

17. The system of claim 15, wherein said instructions for adding an entry comprises software for submitting an add request using a lightweight directory access protocol over a secure sockets layer session connection.

18. The system of claim 15, wherein said instructions for requesting authentication comprises software for submitting a bind request using a lightweight directory access protocol over a transport connection.

19. The system of claim 15, wherein said instructions for requesting authentication comprises software for submitting a bind request using a lightweight directory access protocol over a secure sockets layer session connection.

20. The system of claim 15, wherein said instructions for requesting authentication comprises software for submitting an authentication request using a hypertext transport protocol over a transport connection.
